(19) United States
(12) Patent Application Publication
(10) Pub. No.: US 2006/0160977 A1
(43) Pub. Date: Jul. 20, 2006

(54) Prescription for preparation of non-yellowing polyurethane foam

(76) Inventor: Jung-Shun Ou, Chia Yi Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/034,680

(22) Filed: Jan. 14, 2005

(51) Int. Cl. C08G 18/00

(52) U.S. Cl. 528/44

(57) ABSTRACT

A method for producing low-density non-yellowing open-cell flexible polyurethane foams by reacting active-hydrogen-containing polyols, in the presence of a mixed catalyst and surfactant composition, with mixed aliphatic, or aliphatic-like, organic polyisocyanates comprising essentially of: 1. from about 5 to about 70 parts by weight of hexamethylene diisocyanate; and 2. from about 95 to about 30 parts by weight of 3-isocyanatomethyl-3,5,5-trimethylcyclohexyl-isocyanate, based upon 100-parts by weight of said organic polyisocyanate composition. The organic polyisocyanate composition provides sufficiently viscosity control as the foam reaches its full rise, hence is useful in preparation of open-cell non-yellowing polyurethane foams. In a preferred embodiment, new and improved polyurethane slapstick foam compositions are disclosed which exhibiting ultraviolet light resistance and improved color stability.

### BACKGROUND OF THE INVENTION

1. Field of the Invention

The present invention relates to a process for the preparation of non-yellowing polyurethane foams of density lower than 120 kg/m³ by reacting polyol containing at least two active hydrogen atoms with mixed aliphatic, or aliphatic-like, organic polyisocyanates comprising essentially of
1. from about 5 to about 70 parts by weight of hexamethylene diisocyanate; and
2. from about 95 to about 30 parts by weight of 3-isocyanatomethyl-3,5,5-trimethylcyclohexyl-isocyanate, based upon 100 parts by weight of said organic polyisocyanate composition.

In present invention, the term “aromatic isocyanates” refers to an organic isocyanate compound wherein the is ocyanate group or groups are bonded directly to a carbon atom of an aromatic nucleus. “Aliphatic , or aliphatic-like isocyanates” means an organic isocyanate compound wherein the isocyanate group or groups are bonded directly to an aliphatic carbon atom. The “aliphatic, or aliphatic-like, isocyanate” can be an aliphatic or alicyclic isocyanate. The term polyaliphatic isocyanate means a compound having more than one aliphatic isocyanate linkage in one molecular.

2. Description of Related Art

Polyurethane foams have long been used and are widely described in literature. The polyurethane are usually produced by reacting isocyanates with compounds containing at least two active hydrogen atoms reactive with isocyanate groups in the presence of catalysts, surfactants, and blowing agents. The isocyanates generally used are aromatic di- or polyisocyanates. Isomers of toluene diisocyanate (TDI), isomers of diphenylmethane diisocyanate (MDI), and mixtures of diphenylmethane diisocyanate and polymethylene-polyphenylene polyisocyanates (crude MDI) are of greatest commercial importance.

A serious disadvantage encountered with these conventional polyurethane compositions and foam products prepared therefrom is that polyurethanes based on aromatic isocyanates have extremely poor ultraviolet light stability and undesirable yellowing or other discoloration develops with these materials upon exposure to sunlight or other sources of ultraviolet light. Yellowing of such conventional polyurethanes is due to use of aromatic polyisocyanates which form by oxidation, degradation products having chromophore groups. These polyurethane foams based on aromatic isocyanates generally cause foam yellowing under the action of light. This tendency to yellow causes problem in many applications, for example apparel, medical care, and packaging. In the past, where these aromatic polyurethane compositions and foam products prepared therefrom were utilized to form colored products, such as shoulder pad or the like, they have to be colored to an intense shade, or to a dark shade, in order to hide the undesirable discoloration of the foam. If it was necessary or desired to provide light or bright colored articles, the articles need to be prepared with adding ultraviolet-light stabilizer into polyurethane foam formulation. These additional stabilizers are expensive and inefficient since it can only delay the discoloration for a few weeks. The aromatic polyurethane foams with such ultraviolet-light stabilizer will eventually undergo yellowing within a short period of time.

It is known that polyurethanes, which are prepared using aliphatic isocyanates, are light stable and exhibit no yellowing. However, the aliphatic isocyanates are considerably less reactive than the aromatic isocyanates in both gelling, which is the addition reaction among isocyanate group and active hydrogen atom in a polyol, and blowing, which is the reaction of isocyanate group with water, reactions. In the preferred embodiment, detail description of these reactions is explained. The less reactivity of aliphatic isocyanate prohibits direct replacement of aromatic isocyanate with aliphatic isocyanate in common polyurethane foam formulations.

As described in U.S. Pat. No. 4,242,410, Konig presents a method to apply a foamed top layer, which has light and yellowing resistance based on polyisocyanates, on foam plastic. A mold is firstly coated with a liquid polyurethane-polyurea based coating agent, containing a binder, which react to form a light- and yellowing-resistant top layer and then introducing a foamable reaction mixture into said mold. The method can be used to produce molded polyurethane with improved ultraviolet light stability. However, it cannot be used in applications where slabstock type polyurethane foam of low density is required.

U.S. Pat. No. 5,147,897 describes the preparation of non-yellowing polyurethane foam by reacting an isocyanate-terminated prepolymer, obtained by the addition reaction of a polyol having a number average molecular weight of 100 to 5,000 and containing on the average 2 to 3 functional groups with an aliphatic polyisocyanate in an amount of 1.4 to 2.6 times the hydroxyl equivalent, with water in an amount of 0.4 to 5 times the isocyanate equivalent in the presence of, per 100 parts by weight of the prepolymer, 0.1 to 5 parts by weight of carboxylic acid metal salt or 0.1 to 10 parts by weight of an amine-type catalyst (U.S. Pat. No. 5,147,897, issued on Sep. 15, 1992 to Morimoto et. al.). However, owing to the fact that the unreacted isocyanate groups bonded onto such prepolymer can only have even less reactivity than the original aliphatic isocyanates, this method can only be used to produce high density polyurethane foams and microcellular elastomers where less blowing is involved. It is also a significant disadvantage with the prepolymer process, which requires multiple preparation procedure.

An improvement using similar prepolymer, but with improved catalyst composition is explained by Megna (U.S. Pat. No. 4,607,062, issued on Aug. 19, 1986, to Ignazio S. Megna). Catalyst composition containing lead naphthenate and dialkyltin dicarboxylate compound is used to promote rapid cure rate of polyurethane formulation which contain aliphatic isocyanates. The method has particular application in reaction injection moldable (RIM) polyaliphatic isocyanate based polyurethane compositions. However, it can only be used in such application where extra mold temperature is provided, and cannot be used to produce aliphatic polyurethane slabstock foam, which require no additional heating, and has, in general, density less than 120 kg/m³. Another significant disadvantage with such process is the use of hazardous organic lead catalyst, which has long been proved to be harzardous.

U.S. Pat. No. 4,150,206 describes one-shot production process of an aliphatic polyurethane integral skin foam. Polyol, aliphatic polyisocyanate, water, and catalyst compositions, is reacted in a mould so that a polyurethane integral skin foam is produced. (U.S. Pat. No. 4,150,206, issued on Apr. 17, 1979, to Jourquin et. al.) The catalyst compositions contain (1) diazobicycloalkenes in association with at least an alkali or alkaline-earth metal salt, alcoholate and/or phenolate of an acid, or (2) organic lead compound in association with at least an organic initiator comprising as least one functional group of primary or secondary amine, or (3) organic lead compound in association with diazobicycloalkenes, or (4) organic lead compound in association with at least an alkali or alkaline-earth metal salt, alcoholate and/or phenolate of an acid. However, the process is suitable to produce molded high-density aliphatic polyurethane integral skin foams where extra heating is available from mold and less blowing is involved. It contains the use of hazardous organic lead catalyst and cannot satisfy recent environmental requirement.

Jourquin describes other application with aliphatic polyurethane foam. U.S. Pat. No. 5,656,677 describes the preparation of light stable polyurethane, sprayable by means of a spray pistol. In the process, an active hydrogen containing compound with multiple functionality of primary hydroxyl or NH and/or NH2 groups, together with chain extender and/or cross-linker, and a catalytic system which comprise at least an organic lead, bismuth and/or tin(IV) compound is mixed and sprayed through a spray pistol type applicator onto a mold surface to form a polyurethane film. After the aliphatic polyurethane film has cured by the heated mold surface for several minutes, another conventional aromatic polyurethane composition (MDI or TDI base) with a typical mould foam density of 50 to 600 kg/m³ and a typical free rise density of 50 to 200 kg/m³ is injected into the substantially hollow mould cavity. Light stable polyurethane molded foam with aliphatic top-coat is then produced. The method involves the use of organic lead compound as catalyst as in previous technologies. The method cannot be used to produce aliphatic polyurethane slabstock foam, neither.

U.S. Pat. No. 6,242,555 describes a process to produce microcellular or non-cellular, light-stable, elastomeric, flexible or semi-flexible polyurethane moldings for automotive applications, by reaction injection molding process. Wherein a isocyanate reactive components comprising polyol, chain extender, amine cross-linker, catalyst compositions, antioxidant, and pigment, is reacted with isocyanate component containing an 3-isocyanatomethyl-3,5,5-trimethylcyclohexyl-isocyanate trimer/monomer mixture having an NCO content of from 24.5 to 34% by weight. The catalyst composition consists organolead (II), organobismuth (III), and organotin (IV). The method can be used to produce aliphatic polyurethane microcellular or non-cellular, light stable elastomers having density of at least 900 kg/m³. The method cannot be used to produce an aliphatic polyurethane slabstock foam with density not exceeding 120 kg/m³.

There are efforts to produce low density non-yellowing aliphatic polyurethane foams. As evidenced in U.S. Pat. No. 3,772,218, Lamplugh describes a method to produce a flexible, open-cell, polyurethane foams by reacting xylyene diisocyanate with an active-hydrogen-containing polyol in the presence of a mixed catalyst system comprising alkanolamine, a stannous salt of a carboxylic acid, and a stannic salt of a carboxylic acid. The method utilizes the considerably higher reactivity of xylyene diisocyanate to satisfy the reactivity requirement in forming low-density aliphatic polyurethane foam. However, due to the limit world supply of xylyene diisocyanate and the cost to produce such expensive xylyene diisocyanate, this method has not been commercially produced.

### SUMMARY OF THE INVENTION

The present invention is a method for producing non-yellowing open-cell flexible polyurethane foams by reacting active-hydrogen-containing polyols, in the presence of a mixed catalyst and surfactant composition, with mixed aliphatic, or aliphatic-like, organic polyisocyanates comprising essentially of
1. from about 5 to about 70 parts by weight of hexamethylene diisocyanate; and
2. from about 95 to about 30 parts by weight of 3-isocyanatomethyl-3,5,5-trimethylcyclohexyl-isocyanate, based upon 100 parts by weight of said organic polyisocyanate composition.

The organic polyisocyanate composition provides sufficiently viscosity control as the foam reaches its full rise, hence result in open-cell non-yellowing polyurethane foams. In a preferred embodiment, new and improved polyurethane slabstock foam compositions are disclosed which exhibiting ultraviolet light resistance and improved color stability.

The present invention provides an one-shot method for the preparation of low-density aliphatic polyurethane foam without the use of hazardous organolead catalyst for those applications, which require foam color stability under the exposure of ultraviolet light.

Another objective of the present invention is to provide an economic solution to satisfy apparel industry needs for low cost aliphatic polyurethane slabstock foam, which utilize low cost, mass-produced aliphatic isocyanates.

A yet another objective of present invention is to provide a method to adjust aliphatic polyurethane foam loadability without changing isocyanate index, or changing isocyanate-reactive components.

Another further objective of the present invention is to provide a method for the preparation of non-yellowing, open-cell viscoelastic polyurethane foam for apparel use.

Drawings and the tables only form a part of present specification without any restrictions to present invention.

### BRIEF DESCRIPTION OF THE DRAWINGS

FIG. 1: Typical viscosity and rise profile for flexible polyurethane foam; and

FIG. 2: Gel and rise profile for flexible polyurethane. foam.

### DETAILED DESCRIPTION OF THE INVENTION

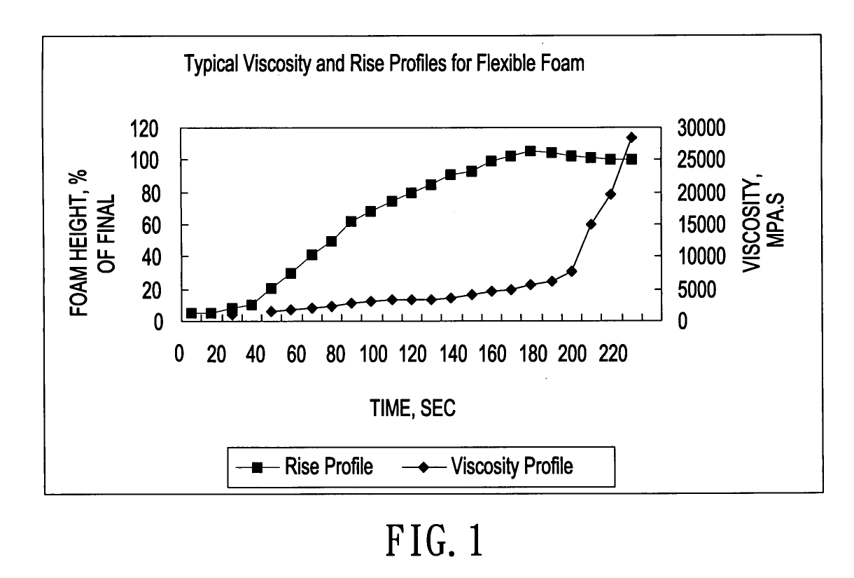

Refer now to FIG. 1, conceptually the opening of cells would occur to a large extent just as the foam reaches its full rise. At that time, the foamed polymer would have reached a high level of viscosity with a very low level of elasticity. The high viscosity would not permit the foam structural elements to flow fast enough to expand and relieve the still-increasing cell-gas pressure. Low elasticity in the cell-window membranes would likewise prohibit reversible stretching of the cell-windows. Under such conditions, the cell-window membranes burst, leaving an interconnected open-cell network. The polymer in the cell-struts must have enough strength to endure this event and prevent splits or catastrophic foam collapse.

As described in prior technology, an aliphatic polyurethane polymer can only be produced with the use of (1) catalysts which have strong basicity, such as diazobicycloalkene type amine, alkali or alkaline-earth metal salt, alcoholate and/or phenolate of acid which has dissociation constant Ka less than 10⁻¹, and/or (2) organometallic catalysts, such as organolead (II), organobismuth (III), and organotin (IV), in order to promote the less reactive polymerization with aliphatic isocyanates.

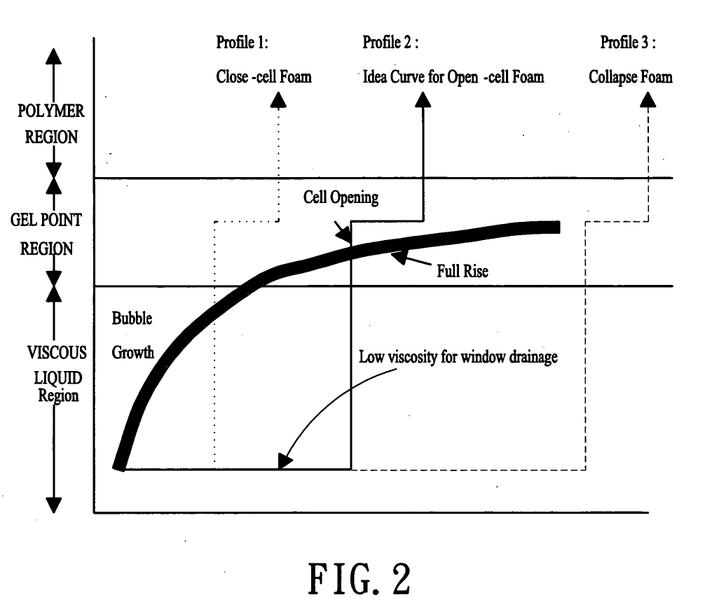

With the use of such strong catalysts in the preparation of aliphatic polyurethane foam, it is difficult to control the reaction rate of such aliphatic isocyanate with polyol and water in order to reach a balance with both gelling and blowing. As now refer to FIG. 2, the gelling profile falls-into the “close-cell foam profile” zone, where a close-cell foam structure is obtain. The close-cell foam is' blown and filled with hot carbon dioxide which is heated up by reaction exotherm. The foam will shrink while the foam cool down, as the inner gas cool-down and reduce its volume. If other type of catalyst is selected for the preparation of aliphatic polyurethane foam, such weaker catalysts can only bring in very weak catalytic effect and result in inadequate gelling. Therefore no foam can be made from using such catalysts. As a conclusion, the formation of aliphatic polyurethane can either be too fast to control and results in foam shrinkage, or too slow to form a practical polyurethane foam materials, while using prior technologies.

It is surprisingly found that low-density, open-cell flexible aliphatic polyurethane foams can be produced utilizing mixture of at least two different types of aliphatic diisocyanates, which have different inherent reactivity under same catalytic condition. The composition in such aliphatic isocyanate mixture can be tailor-made in order to meet specific reactivity requirement for manufacture of open-cell aliphatic polyurethane foam. 1,6-hexane diisocyanate is found with particular interest to provide such control with 3-isocyanatomethyl-3,5,5-trimethylcyclohexyl-isocyanate. The isocyanate combination can reduce the polyaddition reactivity among hydroxyl and isocyanate groups, while have minor reduction in water and isocyanate blowing reaction. It provides control to obtain an ideal open-cell foam profile”, as illustrated in FIG. 2.

The present invention is particularly useful in the manufacture of aliphatic non-yellowing slabstock foam of density less than 120 kg/m³. Traditional polyurethane foam catalyst, such as bis-(N,N-dimethylaminoethyl) ether and organotin(IV), can be used at high concentration to promote both blowing and gelling reactions to form an aliphatic polyurethane slabstock foam, with a mixture of aliphatic diisocyanates described in the present invention.

### DESCRIPTION OF THE PREFERRED EMBODIMENT

While preferred embodiments have been shown and described, it will be understood that various modifications and substitutions may be made thereto without departing from the spirit and scope of the invention. Accordingly, the present invention has been described by way of illustration and is not a limitation. For the ease in explaining the invention, aliphatic slabstock foam formulation is used. However, the present invention can also be suited for other aliphatic polyurethane applications, for example molded foam cushion for furniture parts and integral skin foam for interior trim parts of vehicles.

The three basic chemicals, which are required to produce polyurethane foam, are the isocyanate, the polyol (B) and water. Other materials which are also used in the formulation to control the reaction rates, the foam structure and the processing are:
1. chain-extender (C),
2. cross-linker (D)
3. an amine catalyst (E), or called “blowing catalyst”,
4. a organometallic catalyst (F), or called “gelling catalyst”,
5. a silicone surfactant (G).

Other additives, such as, pigments, antioxidants, flame retardants, fillers may also be used to impart particular characteristics to the polyurethane foam.

Being given that essential effect, which is sought, is the color stability of polyurethane as present invention, a preference is. given to aliphatic and alicyclic polyisocyanates.

Suitable polyisocyanates for the present invention have for example been described in U.S. Pat. No. 4,150,206 and U.S. Pat. No. 5,147,897. Such polyisocyanates are for example for the following: ethylene diisocyanate, propylene-1,2-diisocyanate, ethylidene diisocyanate, 2,2,4-trimethylhexamethylene diisocyanate, 1,6-hexane diisocyanate, cyclohexylene-1,2-diisocyanate, 3-isocyanatomethyl-3,5,5-triethylcyclohexyl-isocyanate, 4,4′-methylene bis(cyclohexylisocyanate) (H12MDI) 2,4′ -methylene-bis(cyclohexyl-isocyanate), 1,4-phenylene diisocyanate, meta- or para-tetramethyl xylene diisocyanate (TMXDI), and the like.

It is particularly found that following isocyanates are more suitable according to the presented invention to produce good quality open-cell foam products: 3-isocyanatomethyl-3,5,5-trimethylcyclohexyl-isocyanate, 1,6-hexane diisocyanate, 4,4′-methylene bis(cyclohexylisocyanate), 2,4′-methylene-bis(cyclohexyl-isocyanate), and meta- or para-tetramethyl xylene diisocyanate.

More suitable isocyanate combination according to the principle of the present invention are:
a. 4,4′-methylene bis(cyclohexylisocyanate) and 1,6-hexane diisocyanate
b. 2,4′-methylene bis(cyclohexylisocyanate) and 1,6-hexane diisocyanate
c. 3-isocyanatomethyl-3,5,5-trimethylcyclohexyl-isocyanate and 1,6-hexane diisocyanate
d. tetramethyl xylene diisocyanate and 4,4′-methylene bis(cyclohexylisocyanate)
e. tetramethyl xylene diisocyanate and 1,6-hexane diisocyanate

In general the polyol component (B) comprised polyether (b1), polyester (b2), and polytetramethylene glycol (b3) type polyol.

Polyether type polyols are formed by polyoxyalkylene compounds having terminal OH groups, which can be either primary or secondary, obtained by polyaddition of propylene oxide and/or ethylene oxide on low molecular weight initiators comprising from 1 to 8 hydroxy or amino groups as described in U.S. Pat. No. 6,313,060 and U.S. Pat. No. 3,778,390.

In a preferred embodiment of the present invention, a suitable polyether polyol (b1) is an addition product of propylene oxide and ethylene oxide on a low molecular weight initiator. The polyether polyol contains ethylene oxide building-block of preferably higher than 15% by weight, and has a primary hydroxyl content higher than 35%. If the ethylene oxide or primary hydroxyl content is low, the polyether polyol will not meet reactivity requirement in forming good quality aliphatic polyurethane foam.

The nominal functionality of polyether polyol, in general, depends on the functionality of the low molecular weight initiator where ethylene oxide and propylene oxide is bonded onto. Polyether polyol of functionality from 2.7 to 5.5 are found with particular use in forming aliphatic polyurethane foam. Polyether polyols used to prepare flexible polyurethane foams typically have equivalent weights between 400 and 2,500. A recent developed polyether polyol family by using double metal cyanide catalyst in the polyether polyol manufacture, as described in WO97/23544 and U.S. Pat. No. 5,470,813, has been found particularly useful to provide adequate reactivity owing to its lower unsaturation content in polyol. Such polyether polyols are commercialized under tradename of ACCLAIM, available from Bayer.

Conversion product of polyether polyol may also be used according to the principle of the present invention. Two product group have been found practicable, the so-called polymer polyols and polyurea polyols. Polymer polyols are the designation given to a group of polyol dispersions which are produced by free radical polymerization of styrene and acrylonitrile in the polyether servicing as the grafting basis, as described in U.S. Pat. No. 5,496,894 and WO99/031160. Polymer polyol is capable to increase foam loadability without much change in foam formulation. The second, technically important group of conversion products is that of polyurea polyols. They are also produced. in the polyol in situ by reaction with other components. The most common components are diisocyanate and diamine, which react to form ureas by polyaddition reaction. In part, combination with the hydroxyl groups of the polyether chain takes place in the manufacture. The stable dispersions obtained are known as polyurea dispersion (PHD) polyethers. Due to the inherent inflammability of the substituted urea in the PHD polyol, this polyol can be used to produce combustion modified polyurethane foam with reduced amount of flame retardant. The preferred PHD polyol that is found suitable for the preparation of aliphatic polyurethane slabstock foam is Desmophen 7619 available from Bayer.

To make a viscoelastic foam, it is often to use a so-called “viscoelastic polyol” composition. The viscoelastic polyols are characterized by high hydroxyl numbers of above 200 and tend to produce a highly crosslinked polyurethane blocks. It is usually formed with isocyanate index lower than 95. The viscoelastic foam polymer usually has glass transition temperature closer to room temperature. Typical examples of viscoelastic polyurethane foam preparation are described in U.S. Pat. No. 6,391,935. Example of such high hydroxyl polyol are U-1000 from Bayer and G30-167 from Huntsman, both contains no ethylene oxide block. The reactivity of such viscoelastic polyol is uauslly higher than traditional flexible foam polyol, which has hydroxyl number from 25 to 60. It is surprisingly found that the present invention can also be used in viscoelastic foam preparation. By selecting the adequate aliphatic isocyanate composition, balance of gelling and blowing can be reached, which result in the product of good quality open-cell aliphatic viscoelastic foam.

Polyester polyols (b2) are substance which contain the ester group as the repeat unit in the polyol chain. They are generally obtained through the polycondensation of multifunctional carboxylic acids and hydroxyl compounds. Further, less commonly used production possibilities for polyesters consist of the polycondensation of hydroxycarboxylic acids, the polymerization of ring esters (lactones). Transesterification is also possible with hydroxyl as well as with carboxyl compounds. Difunctional and higher functional monomers lead to linear, and branched polyesters, respectively. Owing to the strong influence from the hydrogen-bonding within its molecular, polyester polyols are usually have viscosity greater than about 10,000 cps. Slightly branched polyester polyols with hydroxyl number from about 20 to 100 are preferred in present invention. Typical example of polyester polyol is Fomrez™ 50 from Crampton. However, due to the nature tendency of a polyester to undergo hydrolysis in its service life, the use of polyester polyol in the preparation of aliphatic polyurethane foam is limit.

The third useful polyol group is polytetramethylene glycol (b3). Polytetramethylene glycol is produced from polyaddition reaction of tetrahydro furan with the use of Lewis acid. It is ususlly a di-functional polyol with equivalent weight less than 4,000. Polytetramethylene glycol can be mixed with other polyols, or used as sole polyol composition according to the principle of present invention. Preferred polytetramethylene glycol is PTG 100, PTG 850, and PTG 1800 provided from Dairen Chemical Corp.

The chain-extender component (C) comprises low molecular weight multiple functional hydroxyl groups. The chain-extenders are used in particular amount from about 2 to about 20% by weight, and preferably from about 0.5 to about 15% by weight, based on total isocyanate reactive components (B), (C) and (D). Typical examples of the chain-extenders are: ethylene glycol, diethylene glycol, tri-ethylene glycol, tetraethylene glycol, propylene glycol, dipropylene glycol, tripropylene glycol, tetrapropylene glycol, propanediol and its isomers, butanediol and its isomers, pentanediol and its isomers, hexanediol and its isomers.

The cross-linker component (D) is used in an amount from about 0.2 to about 30% by weight, and preferably from 0.5 to about 15% by weight, based on total isocyanate reactive components (B), (C) and (D). The cross-linker have according to the present invention from 2 to 6 functional aliphatic hydroxyl, primary amino, secondary amino groups, and at least one of these functional groups is amino group. Typical example of the cross-linkers are: diisopropylene amine, monoethanolamine, and diethanolamine. Preferred cross-linker is given to diethanoamine.

The amine catalyst component (E) mainly promotes the isocyanate-water reaction, which generate carbon dioxide and hence blow the foam. The amine catalyst is used in an amount of from about 0.3 to about 3.0% by weight, preferably from about 0.5 to about 2.5% by weight, based on total isocyanate reactive components (B), (C) and (D). Except to the traditional polyurethane foam blowing amine catalysts, diazobicycloalkenes are with particular value to promote the isocyanate-water reaction in aliphatic polyurethane foam formulation. Typical example of the amine catalysts are: bis(dimethylaminoethyl)ether, 1,5-diazabicyclo-(4,3,0)nonene-5, 1,8-diazabicyclo-(5,4,0)undecene-7, 1,8-diazabicyclo-(5,3,0)decene-7, 1,5-diazabicyclo-(5,4,0)undecene-5, 1,4-diazabicyclo-(3,3,0)octane-4, and organic salts of the diazabicycloalkenes such as phenol salt. These amines can be used in combination or solely according to the present invention. Preferred amine catalyst is 1,5-diazabicyclo-(5,4,0)undecene from San-Apro Ltd., Japan, and bis(dimethylaminoethyl)ether from TOYO SODA CORP.

The organometallic component (F) mainly promotes the isocyanate-hydroxy and isocyanate-amino reaction. The suitable organometallic components are: bismuth naphthenate, bismuth neodecanoate, bismuth octoate, bismuth versalate, bismuth 2-ethyl hexanoate, zinc naphthenate, zinc octoate, zinc stearate, stannous octoate, dibutyltin dilaurate, dibutyltin diacetate. The organometallic component is used at the level from about 0.2 to about 2.5% by weight, preferably from about 0.6 to about 2.0% by weight, base on total isocyanate reactive components (B), (C) and (D). The catalyst may be a single component, or in most cases a mixture of two or more components. Preferred organometallic catalysts are stannous octoate and bismuth 2-ethyl hexanoate.

One or more surfactants (G) are also employed in the foam-forming composition. The surfactants lower the bulk surface tension, promote nucleation of bubbles, stabilize the rising foam, and emulsify incompatible ingredients. The surfactants typically used in polyurethane foam applications are polysiloxane-polyoxyalkylene copolymers, which are generally used at levels from about 0.5 to about 3% by weight, preferably from about 0.5 to about 1.5% by weight, base on total isocyanate reactive components (B), (C) and (D). Traditional surfactants used in common aromatic polyurethane foam can also be used in present invention.

Optionally, other additives may be incorporated into the foam-forming composition. The optional additives include, but not limited to, pigments, antioxidants, flame retardants, fillers, recycle foam powder, stabilizers, antimicrobial compounds, and antistatic agents. Such additives should not have a detrimental effect on the properties of the final aliphatic polyurethane foam.

The foam-forming process may be carried out batch-wise, semi-continuously, or continuously on commercial flexible polyurethane foam production line without the need to modify the production facilities.

What is claimed is:

1. A prescription for preparation of non-yellowing polyurethane, which comprising:
an isocyanate composition contains at least two different type of aliphatic or alicyclic polyisocyanate wherein the isocyanate group or groups are bonded directly to an aliphatic carbon atom, with an isocyanate reactive composition; comprising:
a polyol mixture of 65 to 95 percent by weight of total isocyanate reactive composition;
a chain extender with multiple hydroxy functional groups of 0.5 to 15 percent by weight of total isocyanate reactive composition;
a cross-linker with multiple hydroxyl, or primary amino, or secondary amino functional groups, wherein at least one functional group is amino functional group, and of 0.5 to 15 percent by weight of total isocyanate reactive composition;
an amount of water of 0.4 to 5.0 percent by weight of total isocyanate reactive composition; and
a minor effective amount of a catalyst composition.

2. The prescription of claim 1, wherein said catalyst composition comprises: 1. organotin (II or IV) from 40 to 75 percent by weight of total catalyst composition; and 2. 1,8-diazabicyclo-(5,4,0)undecene-7, or its organic salts from 60 to 25 percent by weight of total catalyst composition.

3. The prescription of claim 1, wherein the resulting aliphatic polyurethane foam has a density from 20 kg/m³to 120 kg/m³.

4. The prescription of claim 1, wherein the isocyanate composition contains 3-isocyanatomethyl-3,5,5-trimethylcyclohexyl-isocyanate from 98 to 30 mole ratio, base on total isocyanate composition; and 1,6-hexane diisocyanate from 2 to 70 mole ratio, base on total isocyanate composition.

5. The prescription of claim 1, wherein the isocyanate composition contains methylene bis(cyclohexylisocyanate) from 80 to 30 mole ratio, base on total isocyanate composition; and 1,6-hexane diisocyanate from 20 to 70 mole ratio, base on total isocyanate composition.

6. The prescription of claim 4, wherein the isocyanate index is from 80 to 125.

7. The prescription of claim 5, wherein the isocyanate index is from 90 to 125.

8. The prescription of claim 1, wherein the apliphatic polyurethane foam has full rise time of from 90 seconds to 240 seconds.

9. The prescription of claim 1, wherein the polyol mixture comprises polyether polyol of a functionality from 2.7 to 6.0, and of hydroxyl number from 150 to 300, and is from 50 to 80 percent by weight, based on total polyol mixture.

10. The prescription of claim 1, the chain extender is di-ethylene glycol,
and the crosss-linker is diethanolamine.

11. The prescription of claim 9, wherein the isocyanate composition contains 3-isocyanatomethyl-3,5,5-trimethylcyclohexyl-isocyanate from 80 to 30 mole ratio, base on total isocyanate composition; and 1,6-hexane diisocyanate from 20 to 70 mole ratio, base on total isocyanate composition.

12. The prescription of claim 11, wherein the isocyanate index is from 70 to 100.

13. The prescription of claim 12, the aliphatic polyurethane foam is viscoelastic foam.

14. The prescription of claim 13, wherein the viscoelastic foam has a viscosity recovery time from 90% compression to 10% compression of in the range of 10 seconds to 40 seconds.

15. The prescription of claim 13, wherein the viscoelastic foam has a density in the range of 50 to 120 kg/m³.
